(19) United States
(12) Patent Application Publication
(10) Pub. No.: US 2002/0069765 A1
(43) Pub. Date: Jun. 13, 2002

(54) Method of making an enhanced value meat product and meat product made thereby

(75) Inventor: Fred Frey, Quarryville, PA (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Frey Family Angus

(21) Appl. No.: 09/734,132

(22) Filed: Dec. 11, 2000

Related U.S. Application Data
(60) Provisional application No. 60/177,097, filed on Jan. 20, 2000.

(51) Int. Cl. A23L 1/00

(52) U.S. Cl. 99/352; 99/355; 426/523

(57) ABSTRACT

Briefly stated, the present invention comprises a method of preparing a meat product and, in one embodiment, a method of preparing a beef product from a beef round. The method comprises the steps of cutting a generally solid, generally low fat meat muscle, in one embodiment the beef round, across the grain into two or more muscle portions with each muscle portion having a predetermined thickness. At least one of the muscle portions is cut laterally into a plurality of elongated strips with each strip having a predetermined width and the predetermined thickness. The strips are cooked by placing the strips in hot, deep fat, which is maintained within a predetermined temperature range for a predetermined time period so that the outside of each of the strips becomes crispy and golden brown while the inside remains soft and moist. In a preferred embodiment, the predetermined thickness is the range of ¼ to ½ inch and the predetermined width is also in the range of ¼ to ½ inch. In a preferred embodiment, the predetermined temperature is in the range of 350° F. to 400° F. and the predetermined time period of the cooking is about two minutes.

### CROSS REFERENCE TO RELATED APPLICATIONS

This application claims the benefit of U.S. Provisional Patent Application No. 60/177,097, filed Jan. 20, 2000 and entitled “Method of Making An Enhanced Value Meat Product And Meat Product Made Thereby”.

### BACKGROUND OF THE INVENTION

The present invention relates generally to a meat product having enhanced value, and, more particularly, to a method of making such an enhanced value meat product and the product made in accordance with the method.

The butchering and dressing of animals, such as cattle, for the purpose of producing edible meat or beef products is well known. Animals are typically butchered into a plurality of products, such as rib roasts, sirloin steaks, strip steaks, ground meat, and the like. Typically, a side or quarter of beef is butchered by a meat cutter, cutting or otherwise removing from the standing side or beef quarter as many “high value” beef products as feasible. Such high value beef products include roasts, steaks and the like. Once the high value cuts or products are removed from the standing side or beef quarter, the high value products are further processed by deboning, trimming, cleaning, and the like and are thereafter wrapped and sold for relatively high per pound prices. Such high value cuts generally include the middle cuts of the caucus, including the rib, loin and sirloin. They are typically considered most tender, are derived from the most protected, less stressed animal muscles and generally have a fine, close-grain texture.

Other, less desirable or lower value beef components are also removed from the remainder of the side or beef quarter and are sold separately as less valuable products, such as lower quality roasts (pot roasts) or are placed in a meat grinder for making ground beef. Typically, the less desirable components come from large, complex muscles having coarse or diverse grains, unlike the fine, close-grain texture typically found in the higher value products. Such lesser desirable products and/or ground beef are typically considered to be commodities and are generally sold at a relatively low per pound price.

As the cost of bringing beef and other animal products to market has risen, a need has also risen for obtaining enhanced value from the beef or other animal. One way to provide such enhanced value is to reduce the amount of the beef, which must be sold at a relatively low per pound price. The present invention comprises a method of transforming a less desirable, generally low price per pound meat cut into a meat product with enhanced value and which, therefore, can be marketed at a substantially higher per pound price.

### BRIEF SUMMARY OF THE INVENTION

Briefly stated, the present invention comprises a method of preparing a meat product and, in one embodiment, a method of preparing a beef product from a beef round. The method comprises the steps of cutting a generally solid, generally low fat meat muscle, in one embodiment the beef round, across the grain into two or more muscle portions with each muscle portion having a predetermined thickness. At least one of the muscle portions is cut laterally into a plurality of elongated strips with each strip having a predetermined width and the predetermined thickness. The strips are cooked by placing the strips in hot, deep fat, which is maintained within a predetermined temperature range for a predetermined time period so that the outside of each of the strips becomes crispy and golden brown while the inside remains soft and moist. In a preferred embodiment, the predetermined thickness is the range of ¼ to ½ inch and the predetermined width is also in the range of ¼ to ½ inch. In a preferred embodiment, the predetermined temperature is in the range of 350° F. to 400° F. and the predetermined time period of the cooking is about two minutes.

### BRIEF DESCRIPTION OF THE SEVERAL VIEWS OF THE DRAWING

The foregoing summary, as well as the following detailed description of preferred embodiments of the invention, will be better understood when read in conjunction with the appended drawing. For the purpose of illustrating the invention, there is shown in the drawing embodiments which are presently preferred. It should be understood, however, that the invention is not limited to the precise arrangements and instrumentalities shown. In the drawing:

FIG. 1 is a perspective view of a beef round being cut into smaller portions in accordance with a preferred embodiment of the present invention; and

FIG. 2 is a perspective view of one of the portions cut from the beef round of FIG. 1 being cut into smaller sized strips.

### DETAILED DESCRIPTION OF THE INVENTION

The present invention relates to a method of adding value to meat by cutting the meat in a particular manner and performing other processing steps in a manner as described in detail below. For the purpose of the present invention, the term “meat” shall include, but is not limited to beef, pork, lamb, buffalo, and virtually any other type of “red” or “white” meat or any other meat of a type generally consumed by humans. While the remainder of the present application will focus upon beef, it should be clearly understood by those skilled in the art that the present invention is not limited to beef but, is intended to cover any type of meat. Likewise, while the preferred embodiments of the present invention are described below as being employed in conjunction with a particular cut of beef (i.e., the bottom round 10), for the purpose of enhancing value thereof, it should be clearly understood by those skilled in the art that the present invention is not limited to a particular muscle or cut of beef. That is, the present invention is equally applicable to other muscles or cuts of beef, such as the chuck, tenderloin, sirloin, etc., or virtually any other cut of beef. Similarly, the present invention is equally applicable to virtually any muscle or cut of any other animal which may be consumed by humans.

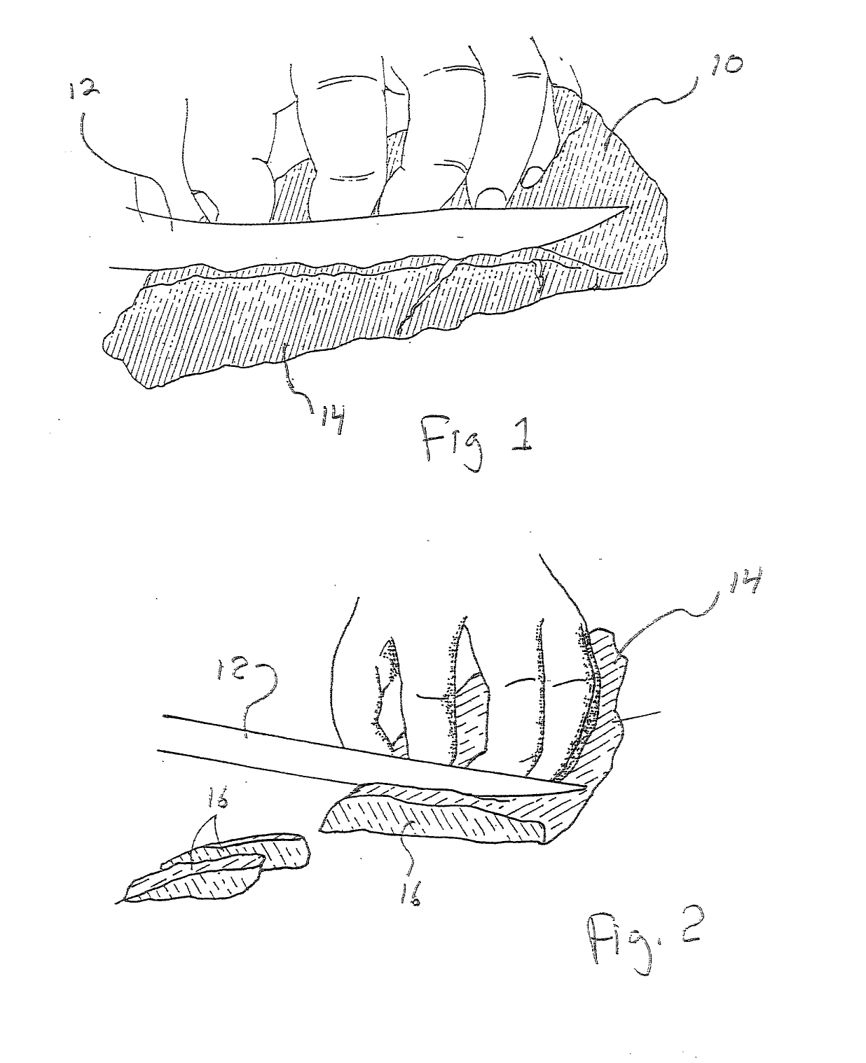

The primary steps involved in performing the preferred embodiment of the present invention are set forth below. The initial step involves obtaining all or a portion of a bottom round cut or roast 10 of beef or any other generally solid, low fat muscle. The bottom round 10 is then cut, in the present embodiment using a knife 12, across the grain as shown in FIG. 1 into several solid muscle portions 14, each muscle portion 14 being approximately one-quarter of an inch to one-half of an inch thick. The length and width of the muscle portions 14 will vary depending upon the initial size and shape of the beef round 10 being cut. In present embodiment, the muscle portions 14 cut from the beef round 10 are then laid flat and are cut laterally, i.e., with the grain, into a plurality of generally, elongated strips 16. Each strip 16 preferably has a width in the range of one-quarter of an inch to one-half of an inch, and a thickness in the range of one-quarter of an inch to one-half of an inch. The overall length of each of the strips 16 will vary depending upon the initial size and shape of the beef round 10 or round portions 14 being cut but preferably are in the range of two to ten inches in length. It will be appreciated by those of ordinary skill in the art that the beef round 10 and round portions 14 may be cut utilizing a meat saw, a sharp boning or other steel knife 12, a water knife or using any other manual or power tool known to those of ordinary skill in the art. Preferably, the beef round 10 is initially in a chilled, but unfrozen state just prior to cutting. Alternatively, the beef round 10 could be partially frozen or completely frozen prior to the initiation of the cutting steps described above.

As an alternative embodiment, some or all of the strips 16 may be further cut (not shown) at various locations along their lengths to provide a plurality of mini strips of a generally uniform or non-uniform shorter length which may be in the range of two to three inches. As a further alternative, the muscle portions 14 removed from the beef round 10 may be cut into a plurality of circular, oblong or other shaped nuggets (not shown) with each nugget having a thickness in the range of one-quarter of an inch to one-half of an inch and having, either a regular or irregular shape, as opposed to having an elongated strip-like appearance. Finally, if desired, the entire irregularly shaped muscle portions 14 cut from the beef round 10, each with a thickness in the range of one-quarter of an inch to one-half of an inch, may be further processed (described below) as is (i.e., without being cut into strips, mini strips, nuggets, or the like).

The following description relates to the further processing of the strips 16. However, it should be appreciated by those of ordinary skill in the art that the same or substantially the same processing steps could be used in connection with the mini strips, nuggets, round muscle portions 14 or any other adaptation thereof.

In one embodiment, the strips 16 are “fried” by placing them directly in hot oil, fat or the like, preferably in a deep fat fryer or some other such cooking apparatus, preferably at a temperature in the range of 350° to 400° F. for a predetermined time period of approximately two minutes. It will be appreciated by those of ordinary skill in the art that the precise temperature of the oil in the deep fat fryer and the precise length of time which the strips 16 are fried will vary depending upon the size of the strips 16, the number of strips 16 being cooked, whether the meat is frozen and other factors. The beef strips 16 are preferably deep fat fried until the outsides are golden brown and crispy, while the insides remain soft, moist and preferably, pink in color. The fried beef strips 16 may than be removed from the deep fat fryer, blotted, or drained, if desired, to remove excess fat therefrom and may then be served hot or may be permitted to cool and be served at room temperature. The hot or room temperature beef strips 16 may be consumed as they are or they may be served with a dipping sauce, such as a sweet/sour sauce, barbecue sauce, horseradish sauce, ranch sauce or the like.

If desired, the cooked beef strips 16 may be frozen, packaged and sold for a consumer to reheat and serve at a later time. Alternatively, the cooked beef strips 16 may be chilled, packaged (unfrozen) and sold for later reheating and consumption. As a further alternative, the uncooked beef strips 16 may be packaged and sold (with or without freezing) for later deep fat frying and consumption.

As an alternative to deep fat frying the beef strips 16 as is, the beef strips 16 may be coated or breaded prior to cooking. The breading may be either a light single breading, a double breading, or the like utilizing a commercial breading product, such as Chesterfield breading or any other suitable breading. Alternatively, some other coating, such as a batter, cornmeal coating, or the like may be applied to the beef strips 16 prior to cooking. Whether a breading, a batter or some other coating is applied to the beef strips 16, they are thereafter cooked in the same manner as described above and may be served in the manner as described above. Likewise, the breaded, battered or otherwise coated beef strips 16 may be frozen or refrigerated, packaged and sold for later cooking or reheating in the manner as described above.

Beef strips 16 made in accordance with the steps described above can be sold at a relatively high per pound price. The beef strips 16 may be used as “finger food” at parties, as appetizers in restaurants or the like. When the beef strips 16 are prepared in accordance with the present invention there is no waste and the beef strips 16 have good flavor and provide good “bite”. As discussed, the beef strips 16 may be prepared ahead or may be cooked just prior to consumption. If desired, the beef strips 16 could undergo a marinade process prior to cooking or prior to having the breading or other coating applied thereto.

From the foregoing description, it can be seen that the present invention comprises a method of adding value to a cut of meat and a meat product produced using the method. It will be appreciated by those of ordinary skill in the art that changes may be made to the above-described embodiments without departing from the broad inventive concepts thereof. It should be appreciated, therefore, that the present invention is not limited to the particular embodiments disclosed but is intended to cover all embodiments within the scope or spirit of the invention as defined by the appended claims.

I claim:

1. A method of preparing a meat product comprising the steps of:
cutting a generally solid, generally low fat meat muscle across the grain into two or more muscle portions, each muscle portion having a predetermined thickness;
cutting at least one of the muscle portions laterally into a plurality of elongated strips, each strip having a predetermined width and the predetermined thickness; and
cooking the strips by placing the strips in hot, deep fat maintained within a predetermined temperature range for a predetermined time period so that the outside of each of the strips becomes crisp and golden brown while the inside remains soft and moist.

2. The method as recited in claim 1, wherein the predetermined thickness is in the range of ¼ to ½ inch.

3. The method as recited in claim 2, wherein the predetermined width is in the range of ¼ to ½ inch.

4. The method as recited in claim 3, wherein the predetermined temperature is in the range of 350° F. to 400° F.

5. The method as recited in claim 4, wherein the predetermined time period is about two minutes.

6. The method as recited in claim 1, further comprising cutting the strips into a generally uniform length prior to the cooking step.

7. The method as recited in claim 1, wherein the muscle is initially cold but not frozen.

8. The method as recited in claim 1, wherein the muscle is initially frozen.

9. The method as recited in claim 1, further comprising the step of breading the strips prior to the cooking step.

10. The method as recited in claim 1, further comprising the step of applying a coating to the strips prior to the cooking step.

11. The method as recited in claim 1, further comprising the step of marinating the strips prior to the cooking step.

12. The method as recited in claim 1, further comprising the step of chilling and then packaging the cooked strips for later reheating and serving.

13. The method as recited in claim 1, further comprising the step of packaging the strips after the second cutting step and deferring the cooking step for a later time.

14. A meat product prepared in accordance with the method of claim 1.

15. A method of preparing a beef product comprising the steps of:
cutting a beef round muscle across the grain into two or more muscle portions, each muscle portion having a predetermined thickness;
cutting at least one of the muscle portions laterally into a plurality of elongated strips, each strip having a predetermined width and the predetermined thickness; and
cooking the strips by placing the strips in hot, deep fat maintained within a predetermined temperature range for a predetermined time period so that the outside of each of the strips becomes crisp and golden brown while the inside remains soft and moist.

16. The method as recited in claim 15, wherein the predetermined thickness is in the range of ¼ to ½ inch and the predetermined width is in the range of ¼ to ½ inch.

17. The method as recited in claim 16, wherein the predetermined temperature is in the range of 350° to 400° and the predetermined time is about two minutes.

18. A beef product made in accordance with the method of claim 15.

19. A beef product made in accordance with claim 17.
